(19) United States
(12) Patent Application Publication
(10) Pub. No.: US 2026/0210475 A1
(43) Pub. Date: Jul. 23, 2026

(54) PLUG AND COUPLING ASSEMBLY

(71) Applicant: Jentech Precision Industrial Co., LTD., TAOYUAN CITY (TW)

(72) Inventors: Shan Yong CHENG, TAOYUAN CITY (TW); Chin Jui YU, TAOYUAN CITY (TW); Yu Yuan TAI, TAOYUAN CITY (TW); Wei Chi LIN, TAOYUAN CITY (TW); Po Jen CHEN, TAOYUAN CITY (TW); Yi Chen TSAI, TAOYUAN CITY (TW); Yu Ting HSU, TAOYUAN CITY (TW)

(21) Appl. No.: 19/448,127

(22) Filed: Jan. 14, 2026

Related U.S. Application Data
(60) Provisional application No. 63/746,265, filed on Jan. 17, 2025.

(30) Foreign Application Priority Data
Apr. 24, 2025 (TW) 114115603
Nov. 26, 2025 (TW) 114146283

(51) Int. Cl. F16L 37/40; F16L 37/12

(52) U.S. Cl. CPC F16L 37/40; F16L 37/1225

(57) ABSTRACT

A plug includes a plug main body, a plug rear terminal, and a piston. The plug main body includes a circumferential hook protruding from an outer surface of the plug main body. The plug rear terminal is connected to the plug main body. The piston is disposed in the cavity. The piston includes a piston main body, a piston head, and at least two extending portions. The piston main body has a cone surface. The piston head is disposed on the piston main body. The at least two extending portions are connected to the cone surface of the piston main body. The at least two extending portions extend from the cone surface of the piston main body away from the piston head. A notch is defined between the at least two extending portions at a side of the piston main body away from the piston head.

### CROSS - REFERENCE TO RELATED APPLICATION

This application claims priority to U.S. Provisional Application Serial Number 63/746,265 filed January 17, 2025, Taiwan Application Serial Number 114115603, filed April 24, 2025, and Taiwan Application Serial Number 114146283, filed November 26, 2025, the disclosures of which are incorporated herein by reference in their entireties.

### BACKGROUND

### Field of Invention

The present invention relates to a plug and a coupling assembly, especially a quick-released plug and coupling assembly.

### Description of Related Art

For servers, enhancing cooling efficiency has become a critical objective. In particular, the increasing penetration of liquid cooling solutions has driven manufacturers to adopt liquid cooling systems. Among these, quick-release liquid cooling connectors are key components of such systems. However, liquid cooling connectors are the most leakage-prone components in the entire liquid cooling system. Furthermore, there is currently no existing coupling assembly capable of simultaneously achieving a tight engagement between the connectors (i.e., the socket and the plug) and effectively reducing fluid resistance.

Therefore, how to propose a plug and a coupling assembly that can solve the aforementioned problems is one of the problems that the industry is currently eager to invest in research and development resources to solve.

### SUMMARY

In view of this, one purpose of the present disclosure is to provide a plug and a coupling assembly that can solve the aforementioned problems.

In order to achieve the above objective, in accordance with an embodiment of the present disclosure, a plug has a cavity, a front opening and a rear opening respectively located at opposite ends of the cavity. The plug includes a plug main body, a plug rear terminal, and a piston. The plug main body includes a circumferential hook protruding from an outer surface of the plug main body. The front opening defines a front end surface of the plug main body. The plug rear terminal is connected to the plug main body. The rear opening is located at an end of the plug rear terminal away from the plug main body. The piston is disposed in the cavity. The piston includes a piston main body, a piston head, and at least two extending portions. The piston main body has a cone surface. The piston head is disposed on the piston main body. The at least two extending portions are connected to the cone surface of the piston main body. The at least two extending portions extend from the cone surface of the piston main body away from the piston head. A notch is defined between the at least two extending portions at a side of the piston main body away from the piston head.

In one or more embodiments of the present disclosure, the plug further includes a label ring disposed on the plug rear terminal. The label ring is located between the plug rear terminal and the plug main body.

In one or more embodiments of the present disclosure, the label ring includes a ring main body, a convex portion, and an inner bump. The convex portion protrudes outward from the ring main body. The inner bump protrudes inward from the ring main body. The convex portion of the label ring defines a maximum diameter of the plug.

In one or more embodiments of the present disclosure, the piston head of the plug has a front surface at an end of the piston head away from the piston main body. The front surface of the piston head extends in parallel with the front end surface of the plug main body.

In one or more embodiments of the present disclosure, the plug main body further includes a circumferential engaging groove located behind the circumferential hook. A diameter of the circumferential engaging groove is less than a diameter of the plug main body.

In one or more embodiments of the present disclosure, the plug further includes a spring. Two ends of the spring respectively abut against the piston and the plug rear terminal. The at least two extending portions is substantially three extending portions. Each of the three extending portions has an abutting surface formed at a step at an outermost side of an end of the three extending portions away from the piston main body.

In one or more embodiments of the present disclosure, the plug further includes a spring. Two ends of the spring respectively abut against the piston and the plug rear terminal. The at least two extending portions is substantially three extending portions. Each of the three extending portions has an abutting surface located at an end of the three extending portions away from the piston main body.

In one or more embodiments of the present disclosure, the plug further includes a first rubber ring disposed in a piston groove of the piston head. The first rubber ring contacts an inner surface of the plug main body.

In one or more embodiments of the present disclosure, the plug further includes a second rubber ring disposed in an outer accommodating groove of the plug main body. The second rubber ring contacts the plug rear terminal.

In one or more embodiments of the present disclosure, the outer accommodating groove is recessed from the outer surface of the plug main body.

In order to achieve the above objective, in accordance with an embodiment of the present disclosure, a coupling assembly includes a plug and a socket. The plug has a cavity, a front opening and a rear opening respectively located at opposite ends of the cavity. The plug includes a plug main body, a plug rear terminal, and a piston. The plug main body includes a circumferential hook protruding from an outer surface of the plug main body. The front opening defines a front end surface of the plug main body. The plug rear terminal is connected to the plug main body. The rear opening is located at an end of the plug rear terminal away from the plug main body. The piston is disposed in the cavity. The piston includes a piston main body, a piston head, and at least two extending portions. The piston main body has a cone surface. The piston head is disposed on the piston main body. The at least two extending portions are connected to the cone surface of the piston main body. The at least two extending portions extend from the cone surface of the piston main body away from the piston head. A notch is defined between the at least two extending portions at a side of the piston main body away from the piston head. The socket is coupled with the plug. The socket includes a socket main body, a clip ring, a sleeve, and a stem. The socket main body accommodates the plug main body. The clip ring is movably disposed on the socket main body. A portion of the clip ring is located in the socket main body. The sleeve is disposed in the socket main body. The plug main body abuts against the sleeve. The stem is disposed in the socket main body. The sleeve surrounds the stem. The piston abuts against the stem.

In one or more embodiments of the present disclosure, the plug further includes a label ring disposed on the plug rear terminal. The label ring is located between the plug rear terminal and the plug main body.

In one or more embodiments of the present disclosure, the label ring includes a ring main body, a convex portion, and an inner bump. The convex portion protrudes outward from the ring main body. The inner bump protrudes inward from the ring main body. The convex portion of the label ring defines a maximum diameter of the plug.

In one or more embodiments of the present disclosure, the piston head of the plug has a front surface at an end of the piston head away from the piston main body. The front surface of the piston head extends in parallel with the front end surface of the plug main body.

In one or more embodiments of the present disclosure, the plug main body further includes a circumferential engaging groove located behind the circumferential hook. A diameter of the circumferential engaging groove is less than a diameter of the plug main body.

In one or more embodiments of the present disclosure, the plug further includes a spring. Two ends of the spring respectively abut against the piston and the plug rear terminal. The at least two extending portions are substantially three extending portions. Each of the three extending portions has an abutting surface formed at a step at an outermost side of an end of the three extending portions away from the piston main body.

In one or more embodiments of the present disclosure, the plug further includes a spring. Two ends of the spring respectively abut against the piston and the plug rear terminal. The at least two extending portions are substantially three extending portions. Each of the three extending portions has an abutting surface located at an end of the three extending portions away from the piston main body.

In one or more embodiments of the present disclosure, the plug further includes a first rubber ring disposed in a piston groove of the piston head. The first rubber ring contacts an inner surface of the plug main body.

In one or more embodiments of the present disclosure, the plug further includes a second rubber ring disposed in an outer accommodating groove of the plug main body. The second rubber ring contacts the plug rear terminal.

In one or more embodiments of the present disclosure, the outer accommodating groove is recessed from the outer surface of the plug main body.

In summary, in the plug and the coupling assembly of the present disclosure, since the piston main body has the cone surface and the two extending portions extend from the cone surface of the piston main body away from the piston head, the fluid resistance encountered when a fluid (e.g., a liquid coolant) flows through the cavity can be reduced, thereby increasing the flow coefficient. In the plug and the coupling assembly of the present disclosure, since the circumferential hook protrudes from the outer surface of the plug main body and the circumferential engaging groove is located behind the circumferential hook, the clip ring of the socket is guided by the circumferential hook into the circumferential engaging groove, such that the clip ring is engaged with the circumferential engaging groove. In the plug and the coupling assembly of the present disclosure, since the convex portion of the label ring defines the maximum diameter of the plug rear terminal, the convex portion of the label ring, which defines the widest part of the plug, provides frictional force when the user holds the plug, thereby preventing the plug from slipping out of the user’s hand. In the plug and the coupling assembly of the present disclosure, since the diameter of the circumferential engaging groove is less than the diameter of the plug main body, after the clip ring of the socket passes over the outer surface of the plug main body and is guided into the circumferential engaging groove by the circumferential hook, the clip ring can more tightly engage with the circumferential engaging groove, thereby making it more difficult for the plug to be detached from the socket. In the plug and the coupling assembly of the present disclosure, since the first rubber ring disposed in the piston groove contacts the inner surface of the plug main body, the fluid inside the cavity is prevented from overflowing when the plug main body moves axially to disengage from the piston. In the plug and the coupling assembly of the present disclosure, since the second rubber ring disposed in an outer accommodating groove of the plug main body contacts the plug rear terminal, the plug rear terminal is less likely to be separated from the plug main body and fluid leakage from the cavity is avoided. In conclusion, the plug and the coupling assembly of the present disclosure not only ensure tight engagement between the socket and the plug, but also reduce the fluid resistance of the fluid flowing through the socket and the plug, thereby improving heat dissipation efficiency.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a perspective view of a plug in accordance with an embodiment of the present disclosure;

FIG. 2 is an exploded view of the plug in accordance with an embodiment of the present disclosure;

FIG. 3 is a perspective view of a piston in accordance with an embodiment of the present disclosure;

FIG. 4 is a top view of the piston in accordance with an embodiment of the present disclosure;

FIG. 5 is a side view of the piston in accordance with an embodiment of the present disclosure;

FIG. 6 is a perspective view of a piston in accordance with another embodiment of the present disclosure;

FIG. 7 is a top view of the piston in accordance with another embodiment of the present disclosure;

FIG. 8 is a side view of the piston in accordance with another embodiment of the present disclosure;

FIG. 9 is a perspective view of a piston in accordance with yet another embodiment of the present disclosure;

FIG. 10 is a top view of the piston in accordance with yet another embodiment of the present disclosure;

FIG. 11 is a side view of the piston in accordance with yet another embodiment of the present disclosure;

FIG. 12 is a cross-sectional view of the plug based on a section 12-12 of FIG. 1 in accordance with an embodiment of the present disclosure;

FIG. 13 is a cross-sectional view of the plug based on a section 13-13 of FIG. 1 in accordance with an embodiment of the present disclosure;

FIG. 14 is a perspective view of a coupling assembly in accordance with an embodiment of the present disclosure; and

FIG. 15 is a cross-sectional view of the coupling assembly based on a section 15-15 of FIG. 14 in accordance with an embodiment of the present disclosure.

### DETAILED DESCRIPTION

Hereinafter, a plurality of embodiments of the present disclosure will be disclosed in diagrams. For the sake of clarity, many details in practice will be described in the following description. However, it should be understood that these details in practice should not limit present disclosure. In other words, in some embodiments of present disclosure, these details in practice are unnecessary. In addition, for simplicity of the drawings, some conventionally used structures and elements will be shown in a simple schematic manner in the drawings. The same reference numbers are used in the drawings and the description to refer to the same or like parts.

Hereinafter, the structure, function, and interconnection relationship of each component included in a plug 100 of this embodiment will be described in detail.

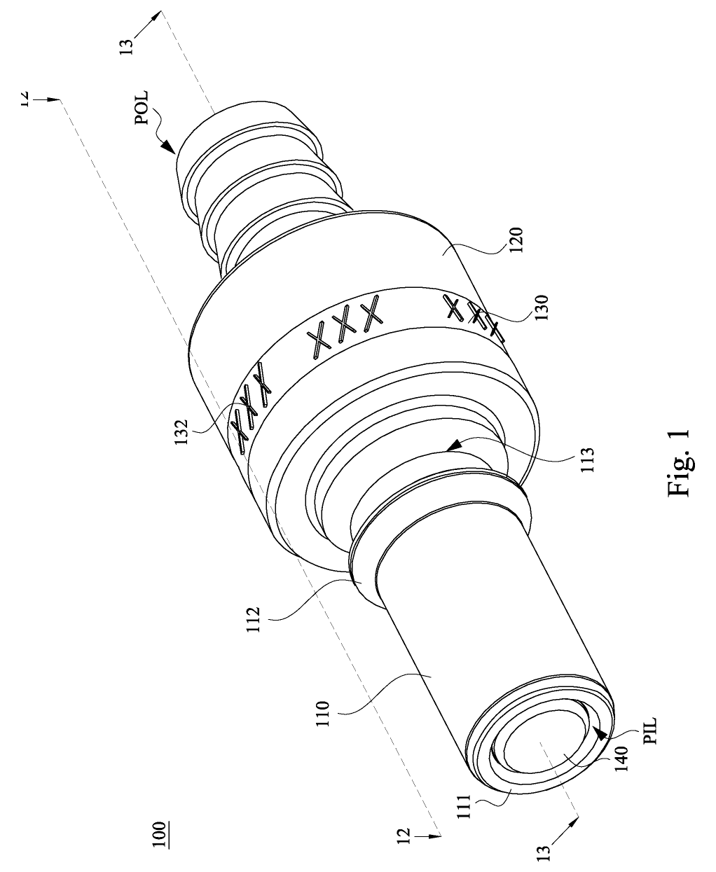

Reference is made to FIG. 1. FIG. 1 is a perspective view of a plug 100 in accordance with an embodiment of the present disclosure. As shown in FIG. 1, in this embodiment, the plug 100 includes a plug main body 110, a plug rear terminal 120, a label ring 130, and a piston 140. The plug 100 has a cavity. The plug 100 further has a front opening PIL and a rear opening POL respectively located at opposite ends of the cavity. The front opening PIL defines a front end surface 111 of the plug main body 110. The rear opening POL is located at an end of the plug rear terminal 120. Specifically, the rear opening POL is located at an end of the plug rear terminal 120 away from the plug main body 110. The cavity of the plug 100 is elongated along an axial direction of the plug main body 110. The plug main body 110 includes a circumferential hook 112 and a circumferential engaging groove 113. The circumferential hook 112 and the circumferential engaging groove 113 extend along a circumferential direction of the plug main body 110. The circumferential hook 112 protrudes from an outer surface of the plug main body 110. The circumferential engaging groove 113 is located behind the circumferential hook 112. The plug rear terminal 120 is connected to the plug main body 110. Specifically, the plug rear terminal 120 is located behind the plug main body 110. The label ring 130 is disposed on the plug rear terminal 120, and the label ring 130 is located between the plug main body 110 and the plug rear terminal 120. The label ring 130 extends along the circumferential direction of the plug main body 110. Specifically, the label ring 130 sleeves around an outer side of the plug rear terminal 120 and is connected between the plug main body 110 and the plug rear terminal 120. In some embodiments, the label ring 130 includes a convex portion 132. The convex portion 132 protrudes from a surface of the label ring 130. The piston 140 is disposed in the cavity of the plug 100. The piston 140 is movable relative to the plug main body 110. In some embodiments, the piston 140 moves along the axial direction of the plug main body 110 relative to the plug main body 110.

In some embodiments, the plug main body 110 and the plug rear terminal 120 may be made of stainless steel or other suitable rigid materials.

In some embodiments, the label ring 130 may be made of plastic, rubber, or other suitable materials.

In some embodiments, the piston 140 may be made of plastic, foam, rubber, or other suitable insulating materials.

In some embodiments, the convex portion 132 may be, for example, arbitrary texts or graphics. Therefore, the present disclosure is not intended to limit the pattern of the convex portion 132.

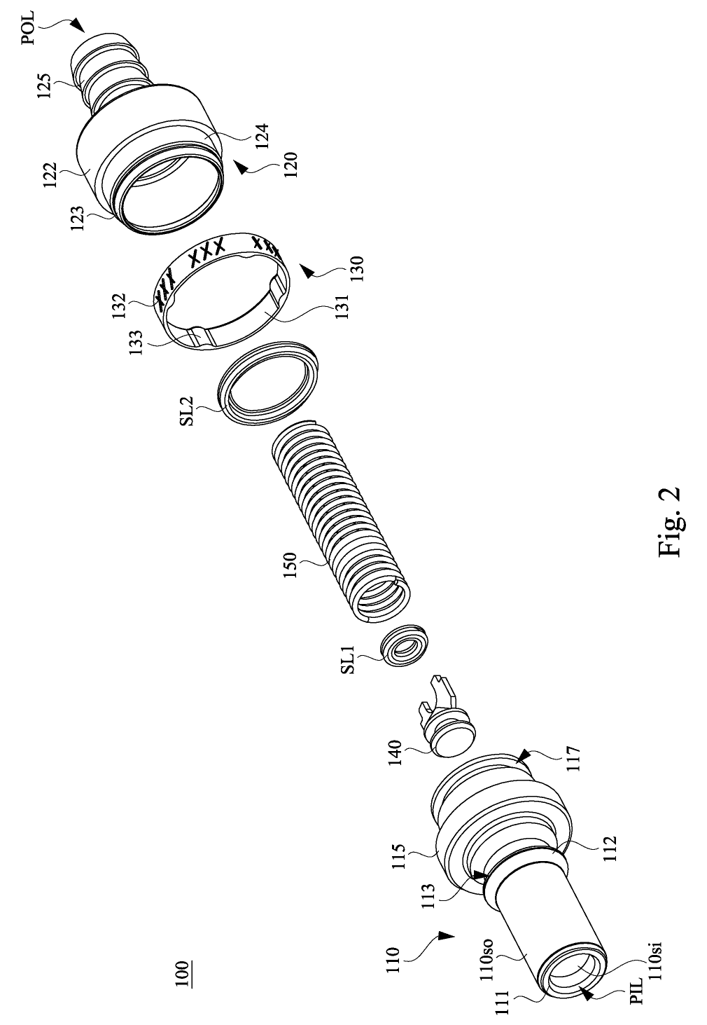

Reference is made to FIG. 2. FIG. 2 is an exploded view of the plug 100 in accordance with an embodiment of the present disclosure. As shown in FIG. 2, in this embodiment, the plug 100 further includes a spring 150, a first rubber ring SL1, and a second rubber ring SL2. The plug main body 110 has an inner surface 110si and an outer surface 110so. The inner surface 110si and the outer surface 110so are surfaces extending along the axial direction and the circumferential direction of the plug main body 110. The plug main body 110 further includes an eaves portion 115 and an outer accommodating groove 117. The eaves portion 115 is located behind the circumferential engaging groove 113. The eaves portion 115 protrudes outward from the outer surface 110so of the plug main body 110. The outer accommodating groove 117 is located behind the eaves portion 115. The outer accommodating groove 117 is recessed from the outer surface 110so of the plug main body 110.

Reference is made again to FIG. 2. As shown in FIG. 2, in this embodiment, the plug rear terminal 120 includes a rear terminal main body 122, a tapering portion 123, a recessed circumferential surface 124, and a connecting portion 125. The rear terminal main body 122 defines a maximum width of the plug rear terminal 120 in the axial direction. It should be noted that although the rear terminal main body 122 defines the maximum width of the plug rear terminal 120 in the axial direction, a maximum width of the plug 100 in the axial direction is defined by the convex portion 132 of the label ring 130 rather than the rear terminal main body 122. In some embodiments, the rear terminal main body 122 may have a cylindrical shape, for example. The tapering portion 123 extends from the rear terminal main body 122, and a diameter of the tapering portion 123 gradually decreases in a direction toward the plug main body 110 along the axial direction. The recessed circumferential surface 124 extends from the rear terminal main body 122 and is located between the rear terminal main body 122 and the tapering portion 123. In some embodiments, a diameter of the recessed circumferential surface 124 and the diameter of the tapering portion 123 are both less than a diameter of the rear terminal main body 122. The connecting portion 125 extends from the rear terminal main body 122, and the connecting portion 125 is located at a side of the rear terminal main body 122 away from the tapering portion 123 and the recessed circumferential surface 124. The rear opening POL is located at an end of the connecting portion 125 of the plug rear terminal 120. Specifically, the rear opening POL is located at an end of the connecting portion 125 away from the plug main body 110. In some embodiments, the connecting portion 125 includes one or more convex rings on a surface thereof, such that the connecting portion 125 is connected to an additional water pipe by the one or more convex rings.

Reference is made again to FIG. 2. As shown in FIG. 2, in this embodiment, the label ring 130 further includes a ring main body 131 and an inner bump 133. The convex portion 132 protrudes outward from the ring main body 131. The inner bump 133 protrudes inward from the ring main body 131. The first rubber ring SL1 is disposed on the piston 140. The second rubber ring SL2 is disposed at a rear end of the plug main body 110.

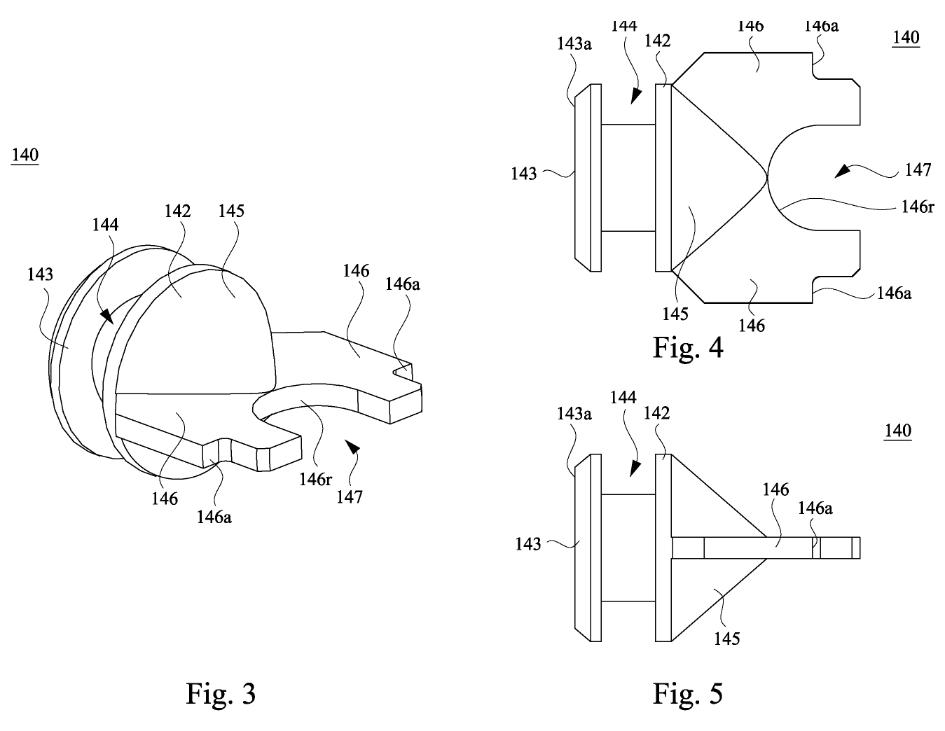

Reference is made to FIG. 3, FIG. 4, and FIG. 5. FIG. 3 is a perspective view of a piston 140 in accordance with an embodiment of the present disclosure. FIG. 4 is a top view of the piston 140 in accordance with an embodiment of the present disclosure. FIG. 5 is a side view of the piston 140 in accordance with an embodiment of the present disclosure. As shown in FIG. 3 to FIG. 5, in this embodiment, the piston 140 includes a piston main body 142, a piston head 143, a piston groove 144, and two extending portions 146. The piston main body 142 has a cone surface 145. Specifically, the piston main body 142 is substantially conical, and the cone surface 145 defines the shape of the piston main body 142. The piston head 143 is disposed on the piston main body 142 and has the piston groove 144. Specifically, a bottom surface of the conical piston main body 142 is connected to the piston head 143, and the piston groove 144 is located at a middle section of the piston head 143. The piston head 143 further has a front surface 143a at an end of the piston head 143 away from the piston main body 142.

Reference is made again to FIG. 3 to FIG. 5. As shown in FIG. 3 to FIG. 5, in this embodiment, the two extending portions 146 are disposed on opposite sides of the piston main body 142. Each of the extending portions 146 extends away from the piston main body 142 in both the axial direction and the radial direction of the plug main body 110. Specifically, the two extending portions 146 extend axially away from the piston main body 142 and simultaneously extend radially outward. The two extending portions 146 extend from the cone surface 145 of the piston main body 142 away from the piston head 143. In other words, the cone surface 145 of the piston main body 142 is connected to the two extending portions 146, and an apex of the conical piston main body 142 is not connected to the piston head 143. In some embodiments, the apex of the conical piston main body 142 is connected to the two extending portions 146. A composite of the two extending portions 146 is substantially plate-shaped. The two extending portions 146 have abutting surfaces 146a respectively located on opposite sides of the two extending portions 146. The abutting surfaces 146a are configured to allow an end of the spring 150 to abut thereagainst. Inner sides of the two extending portions 146 form a domed surface 146r and define a notch 147. Specifically, the notch 147 is defined between the two extending portions 146, and the notch 147 is located at a side of the piston main body 142 away from the piston head 143. The shape of the notch 147 is defined by the domed surface 146r. In some embodiments, the notch 147 is defined by the piston main body 142 and the two extending portions 146. In some embodiments, the notch 147 has a round arch shape, but the present disclosure is not intended to limit the shape of the notch 147. The design of the piston 140 helps reduce the fluid resistance encountered by fluid flowing through the piston 140.

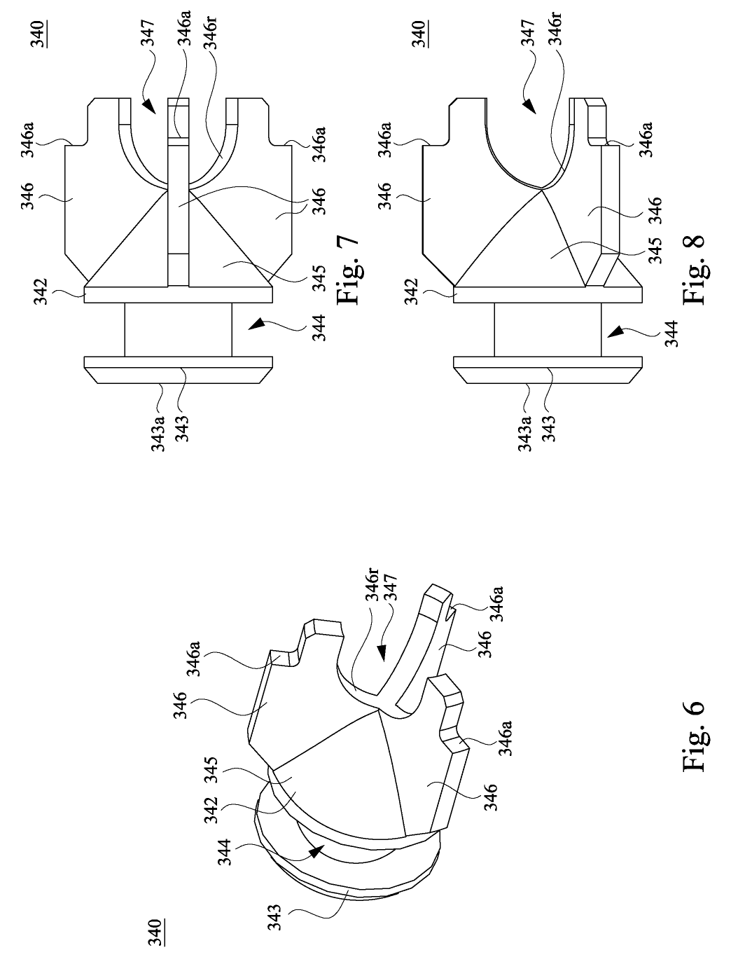

Reference is made to FIG. 6, FIG. 7, and FIG. 8. FIG. 6 is a perspective view of a piston 340 in accordance with another embodiment of the present disclosure. FIG. 7 is a top view of the piston 340 in accordance with another embodiment of the present disclosure. FIG. 8 is a sided view of the piston 340 in accordance with another embodiment of the present disclosure. As shown in FIG. 6 to FIG. 8, in this embodiment, the piston 140 of the plug 100 may alternatively be implemented as a piston 340. Since the structural configuration of the piston 340 is generally similar to that of the piston 140, only the differences will be described in detail below. Compared to the piston 140, the piston 340 includes not only a piston main body 342, a piston head 343, and a piston groove 344, but also at least three extending portions 346. The piston main body 342 has a cone surface 345. The three extending portions 346 are connected to the cone surface 345 of the piston main body 342. Specifically, the three extending portions 346 are evenly distributed on the cone surface 345. The piston head 343 further has a front surface 343a at an end thereof away from the piston main body 342. In some embodiments in which the quantity of the extending portions 346 is three, an angle between any two adjacent extending portions 346 is approximately 120 degrees. The present disclosure is not intended to limit the angle between adjacent extending portions 346. In some embodiments, the quantity of the extending portions 346 may be greater than three (i.e., four or more).

Reference is made again to FIG. 6 to FIG. 8. As shown in FIG. 6 to FIG. 8, in this embodiment, each of the extending portions 346 extends away from the piston main body 342 in both the axial and radial directions of the plug main body 110. Specifically, the three extending portions 346 extend axially away from the piston main body 342 while also extending radially outward. The three extending portions 346 extend from the cone surface 345 of the piston main body 342 away from the piston head 343. In other words, the cone surface 345 of the piston main body 342 is connected to the three extending portions 346, and the apex of the conical piston main body 342 is not connected to the piston head 343. In some embodiments, the apex of the conical piston main body 342 is connected to the three extending portions 346. Each of the three extending portions 346 has an abutting surface 346a located on its outer side. The abutting surface 346a is configured to allow an end of the spring 150 to abut thereagainst. Specifically, the abutting surface 346a is formed by a step at the outermost side of an end of the extending portion 346 away from the piston main body 342, similarly to the abutting surface 146a shown in FIG. 3 to FIG. 5. The inner sides of the three extending portions 346 form a domed surface 346r and define a notch 347. In some embodiments, the notch 347 has a round arch shape. The present disclosure is not intended to limit the shape of the notch 347. The design of the piston 340 also helps reduce the resistance encountered by fluid flowing through the piston 340.

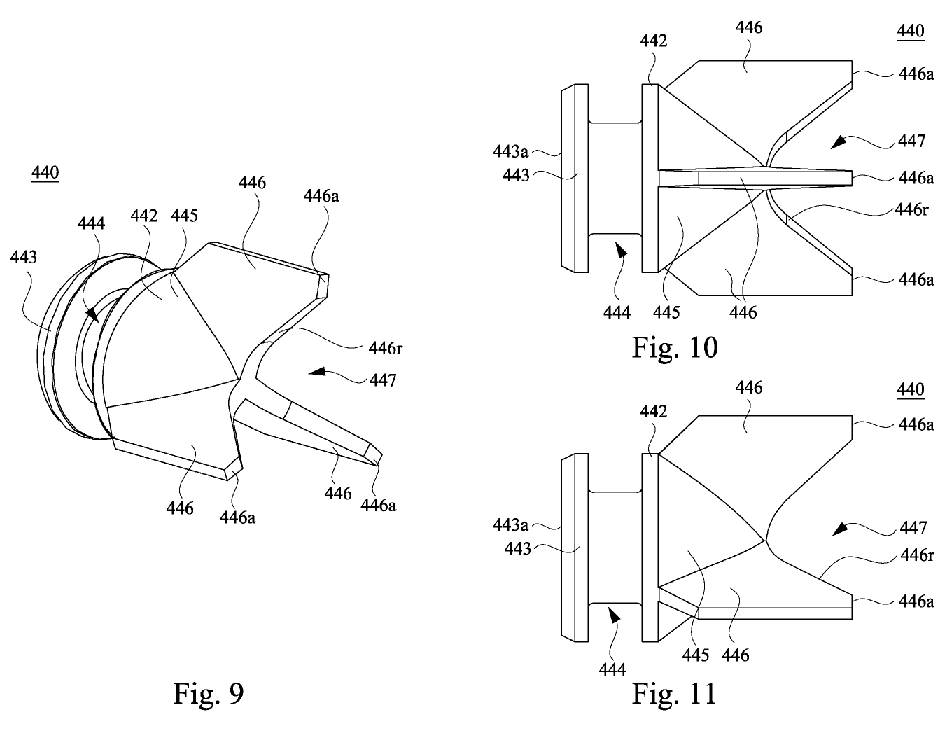

Reference is made to FIG. 9, FIG. 10, and FIG. 11. FIG. 9 is a perspective view of a piston 440 in accordance with yet another embodiment of the present disclosure. FIG. 10 is a top view of the piston 440 in accordance with yet another embodiment of the present disclosure. FIG. 11 is a sided view of the piston 440 in accordance with yet another embodiment of the present disclosure. As shown in FIG. 9 to FIG. 11, in this embodiment, the piston 140 of the plug 100 may alternatively be implemented as a piston 440. Since the structural configuration of the piston 440 is generally similar to that of the piston 140, only the differences will be described in detail below. Compared to the piston 140, the piston 440 includes not only a piston main body 442, a piston head 443, and a piston groove 444, but also three extending portions 446. The piston main body 442 has a cone surface 445. The three extending portions 446 are connected to the cone surface 445 of the piston main body 442. Specifically, the three extending portions 446 are evenly distributed on the cone surface 445. The piston head 443 further has a front surface 443a at an end thereof away from the piston main body 442. In some embodiments in which the quantity of the extending portions 446 is three, an angle between any two adjacent extending portions 446 is approximately 120 degrees. The present disclosure is not intended to limit the angle between adjacent extending portions 446. In some embodiments, the quantity of the extending portions 446 may be greater than three (i.e., four or more).

Reference is made again to FIG. 9 to FIG. 11. As shown in FIG. 9 to FIG. 11, in this embodiment, each of the extending portions 446 extends away from the piston main body 442 in both the axial and radial directions of the plug main body 110. Specifically, the three extending portions 446 extend axially away from the piston main body 442 while also extending radially outward. The three extending portions 446 extend from the cone surface 445 of the piston main body 442 away from the piston head 443. In other words, the cone surface 445 of the piston main body 442 is connected to the three extending portions 446, and the apex of the conical piston main body 442 is not connected to the piston head 443. In some embodiments, the apex of the conical piston main body 442 is connected to the three extending portions 446. Each of the three extending portions 446 has an abutting surface 446a located at an end thereof away from the piston main body 442. The abutting surface 446a is configured to allow an end of the spring 150 to abut thereagainst. Specifically, the end of the piston 440 farthest from the front surface 443a is defined by the abutting surface 446a. In some embodiments, the abutting surface 446a extends parallel to a radial direction of the plug main body 110. The inner sides of the three extending portions 446 form a domed surface 446r and define a notch 447. In some embodiments, the notch 447 has a pointed arch shape. The present disclosure is not intended to limit the shape of the notch 447. In some embodiments in which the notch 447 has a pointed arch shape, a curvature radius of a portion of the domed surface 446r closest to the cone surface 445 is less than a curvature radius of the portion of the domed surface 146r closest to the cone surface 145 and a curvature radius of the portion of the domed surface 346r closest to the cone surface 345. The design of the piston 440 also helps reduce the resistance encountered by fluid flowing through the piston 440.

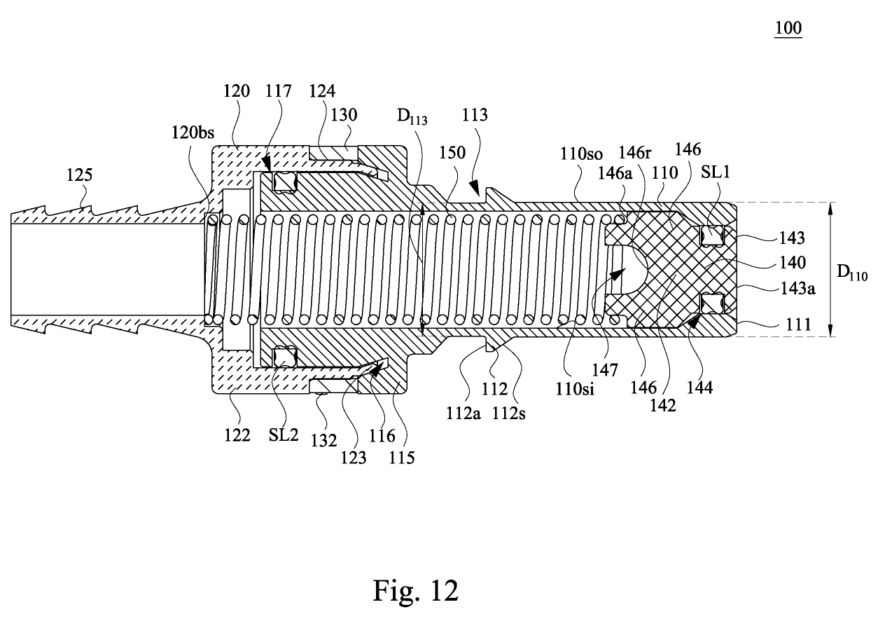

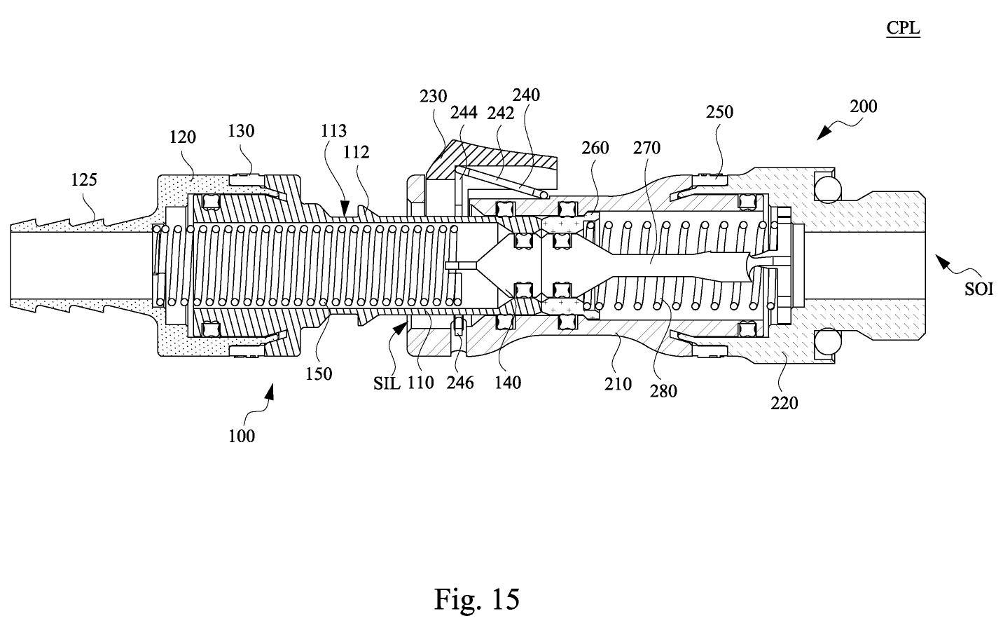

Reference is made to FIG. 12. FIG. 12 is a cross-sectional view of the plug 100 based on a section 12-12 of FIG. 1 in accordance with an embodiment of the present disclosure. As shown in FIG. 12, in this embodiment, the plug main body 110 further has an inner groove 116. The inner groove 116 is defined by a recessed portion between the eaves portion 115 and the plug main body 110. In other words, the inner groove 116 is located directly below the eaves portion 115, and the eaves portion 115 covers the tapering portion 123 of the plug rear terminal 120. The circumferential hook 112 has an inclined surface 112s and an engaging surface 112a. The engaging surface 112a is connected to the inclined surface 112s, and the engaging surface 112a is located behind the inclined surface 112s. In some embodiments, the inclined surface 112s extends outward in a direction away from the front end surface 111 of the plug main body 110. The engaging surface 112a extends perpendicular to the outer surface 110so of the plug main body 110. As shown in FIG. 12, the plug main body 110 has a diameter D₁₁₀ in the radial direction, and the circumferential engaging groove 113 has a diameter D₁₁₃in the radial direction. In some embodiments, the diameter D₁₁₃ of the circumferential engaging groove 113 is less than the diameter D₁₁₀of the plug main body 110. This allows the plug 100 to be more tightly engaged with a socket 200 (as shown in FIG. 14 and FIG. 15) when the plug 100 is coupled with the socket 200.

Reference is made again to FIG. 12. As shown in FIG. 12, in this embodiment, the second rubber ring SL2 is disposed in the outer accommodating groove 117. Specifically, the outer accommodating groove 117 accommodates the second rubber ring SL2. The second rubber ring SL2 contacts the plug rear terminal 120. Specifically, the second rubber ring SL2 simultaneously contacts both the outer accommodating groove 117 of the plug main body 110 and an inner surface of the plug rear terminal 120. This enables the plug rear terminal 120 to be more tightly connected to the plug main body 110.

Reference is made again to FIG. 12. As shown in FIG. 12, in this embodiment, the tapering portion 123 of the plug rear terminal 120 is located in the inner groove 116, while the recessed circumferential surface 124 of the plug rear terminal 120 is not located in the inner groove 116. The label ring 130 is disposed on the recessed circumferential surface 124. The first rubber ring SL1 is disposed in the piston groove 144 of the piston head 143. The first rubber ring SL1 contacts the inner surface 110si of the plug main body 110. Specifically, the first rubber ring SL1 simultaneously contacts the piston groove 144 of the piston 140 and the inner surface 110si of the plug main body 110. This prevents fluid in the cavity of the plug main body 110 from leaking out when the piston 140 is disengaged from the inner surface 110si of the plug main body 110 in a direction away from the front end surface 111. As shown in FIG. 12, the front surface 143a of the piston head 143 extends in parallel with the front end surface 111 of the plug main body 110.

Reference is made again to FIG. 12. As shown in FIG. 12, in this embodiment, two ends of the spring 150 respectively abut against the piston 140 and the plug rear terminal 120. Specifically, the two ends of the spring 150 respectively abut against the abutting surface 146a of the piston 140 and an abutting surface 120bs of the plug rear terminal 120. The abutting surface 120bs is located at a step formed by a variation in an inner diameter of the plug rear terminal 120. Therefore, the piston 140 can reciprocally move relative to the plug main body 110 by the spring 150.

In some embodiments, the notch 147 serves as a recessed portion of the piston 140. This allows the rear portion of the piston 140 to occupy less volume in the cavity of the plug main body 110, thereby increasing the flow coefficient.

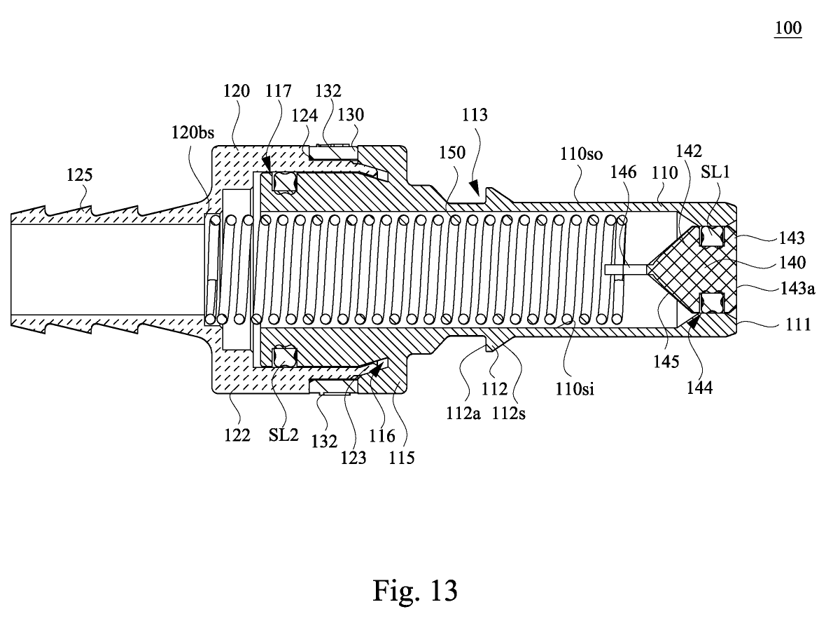

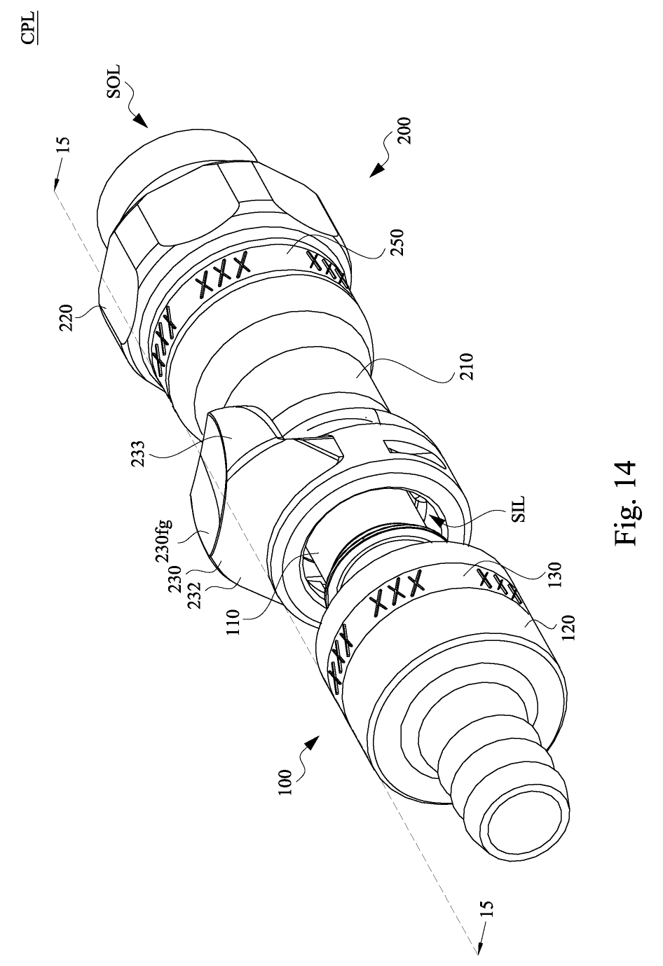

Reference is made to FIG. 13. FIG. 13 is a cross-sectional view of the plug 100 based on a section 13-13 of FIG. 1 in accordance with an embodiment of the present disclosure. As shown in FIG. 13, in this embodiment, since the extending portions 146 are plate-shaped and the piston main body 142 has the cone surface 145, the rear portion of the piston 140 occupies less volume in the cavity of the plug main body 110, thereby increasing the flow coefficient. As shown in FIG. 13, it is apparent that the convex portion 132 of the label ring 130 defines the maximum diameter of the plug 100. This allows the convex portion 132 of the label ring 130 to provide sufficient friction when a user holds the plug 100, thereby making the plug 100 less likely to slip from the user's hand.

Hereinafter, the structure, function, and interconnection relationship of each component included in a coupling assembly CPL of this embodiment will be described in detail.

Reference is made to FIG. 14. FIG. 14 is a perspective view of a coupling assembly CPL in accordance with an embodiment of the present disclosure. As shown in FIG. 14, in this embodiment, the coupling assembly CPL includes the aforementioned plug 100 and a socket 200. The socket 200 is coupled with the plug 100. Specifically, the plug 100 enters the cavity of the socket 200 from a front opening SIL of the socket 200. The socket 200 includes a socket main body 210, a socket rear terminal 220, a pressing part 230, and a label ring 250. The socket main body 210 accommodates the plug main body 110. The socket rear terminal 220 is connected to the socket main body 210 and is located behind the socket main body 210. A rear opening SOL is located at an end of the socket rear terminal 220 away from the plug 100. The pressing part 230 is disposed on the socket main body 210 and moves relative to the socket main body 210 in the radial direction. The pressing part 230 includes a pressing main body 232 and a tongue portion 233. The pressing part 230 further has an arc surface 230fg. The label ring 250 is disposed between the socket main body 210 and the socket rear terminal 220.

Reference is made to FIG. 15. FIG. 15 is a cross-sectional view of the coupling assembly CPL based on a section 15-15 of FIG. 14 in accordance with an embodiment of the present disclosure. As shown in FIG. 15, in this embodiment, the socket 200 further includes a clip ring 240, a sleeve 260, a stem 270, and a spring 280. The clip ring 240 is movably disposed on the socket main body 210. A portion of the clip ring 240 is located in the socket main body 210. In detail, the clip ring 240 includes an elastic portion 242, an upper embedded ring portion 244, and an engaging ring portion 246. The elastic portion 242 is connected to the upper embedded ring portion 244. The upper embedded ring portion 244 is connected between the elastic portion 242 and the engaging ring portion 246. Specifically, the elastic portion 242 includes opposite ends arranged along the axial direction of the socket main body 210. An end of the elastic portion 242 is connected to the upper embedded ring portion 244. A composite of the upper embedded ring portion 244 and the engaging ring portion 246 extends substantially along the circumferential direction of the socket main body 210. The sleeve 260 is disposed in the cavity of the socket main body 210 and has a generally annular shape, and the plug main body 110 abuts against the sleeve 260. The sleeve 260 includes a first portion and a second portion connected to each other in the axial direction. The second portion is located behind the first portion. A diameter of the first portion of the sleeve 260 is less than a diameter of the second portion of the sleeve 260. The stem 270 is disposed in the cavity of the socket main body 210, and the sleeve 260 surrounds the stem 270. The piston 140 abuts against the stem 270. The spring 280 is disposed in the cavity of the socket main body 210 and surrounds the stem 270.

In a usage scenario, when the coupling assembly CPL is in a state shown in FIG. 15, the plug main body 110 of the plug 100 abuts against the sleeve 260 of the socket 200, and the piston 140 of the plug 100 abuts against the stem 270. Next, when a user intends to operate the plug 100 and the socket 200 to move toward each other, the piston 140 abuts against the relatively stationary stem 270, such that the plug main body 110 of the plug 100 pushes the sleeve 260 to move axially toward the rear opening SOL. Meanwhile, the piston 140 disengages from a front end of the plug main body 110, and both the spring 150 and the spring 280 are elastically compressed. Next, as the user continues to operate the plug 100 and the socket 200 to move further toward each other, the circumferential hook 112 contacts the engaging ring portion 246 of the clip ring 240, and the clip ring 240 moves downward due to the engaging ring portion 246 guided by the inclined surface 112s of the circumferential hook 112. Next, when the engaging ring portion 246 passes over the inclined surface 112s of the circumferential hook 112 and reaches the circumferential engaging groove 113, the clip ring 240 returns to its original position and is tightly engaged with the circumferential engaging groove 113, thereby realizing the coupling of the plug 100 and the socket 200.

Conversely, as shown in FIG. 14 and FIG. 15, when the user intends to separate the plug 100 and the socket 200 from each other, the user may press the arc surface 230fg of the pressing part 230 with a fingertip, causing the clip ring 240 to move downward. Accordingly, the engaging ring portion 246 of the clip ring 240 is no longer located in a range of the cavity of the socket main body 210 in the axial direction, such that the plug main body 110 is no longer blocked by the engaging ring portion 246 and can be detached from the socket 200.

From the above detailed description of the specific embodiments of the present disclosure, it can be clearly seen that in the plug and the coupling assembly of the present disclosure, since the piston main body has the cone surface and the two extending portions extend from the cone surface of the piston main body away from the piston head, the fluid resistance encountered when a fluid (e.g., a liquid coolant) flows through the cavity can be reduced, thereby increasing the flow coefficient. In the plug and the coupling assembly of the present disclosure, since the circumferential hook protrudes from the outer surface of the plug main body and the circumferential engaging groove is located behind the circumferential hook, the clip ring of the socket is guided by the circumferential hook into the circumferential engaging groove, such that the clip ring is engaged with the circumferential engaging groove. In the plug and the coupling assembly of the present disclosure, since the convex portion of the label ring defines the maximum diameter of the plug rear terminal, the convex portion of the label ring, which defines the widest part of the plug, provides frictional force when the user holds the plug, thereby preventing the plug from slipping out of the user’s hand. In the plug and the coupling assembly of the present disclosure, since the diameter of the circumferential engaging groove is less than the diameter of the plug main body, after the clip ring of the socket passes over the outer surface of the plug main body and is guided into the circumferential engaging groove by the circumferential hook, the clip ring can more tightly engage with the circumferential engaging groove, thereby making it more difficult for the plug to be detached from the socket. In the plug and the coupling assembly of the present disclosure, since the first rubber ring disposed in the piston groove contacts the inner surface of the plug main body, the fluid inside the cavity is prevented from overflowing when the plug main body moves axially to disengage from the piston. In the plug and the coupling assembly of the present disclosure, since the second rubber ring disposed in an outer accommodating groove of the plug main body contacts the plug rear terminal, the plug rear terminal is less likely to be separated from the plug main body and fluid leakage from the cavity is avoided. In conclusion, the plug and the coupling assembly of the present disclosure not only ensure tight engagement between the socket and the plug, but also reduce the fluid resistance of the fluid flowing through the socket and the plug, thereby improving heat dissipation efficiency.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A plug having a cavity, a front opening and a rear opening respectively located at opposite ends of the cavity, the plug comprising:
a plug main body comprising a circumferential hook protruding from an outer surface of the plug main body, wherein the front opening defines a front end surface of the plug main body;
a plug rear terminal connected to the plug main body, and the rear opening being located at an end of the plug rear terminal away from the plug main body; and
a piston disposed in the cavity, the piston comprising:
a piston main body having a cone surface;
a piston head disposed on the piston main body; and
at least two extending portions connected to the cone surface of the piston main body, and the at least two extending portions extending from the cone surface of the piston main body away from the piston head, wherein a notch is defined between the at least two extending portions at a side of the piston main body away from the piston head.

2. The plug of claim 1, further comprising a label ring disposed on the plug rear terminal, wherein the label ring is located between the plug rear terminal and the plug main body.

3. The plug of claim 2, wherein the label ring comprises:
a ring main body;
a convex portion protruding outward from the ring main body; and
an inner bump protruding inward from the ring main body,
wherein the convex portion of the label ring defines a maximum diameter of the plug.

4. The plug of claim 1, wherein the piston head of the plug has a front surface at an end of the piston head away from the piston main body, and the front surface of the piston head extends in parallel with the front end surface of the plug main body.

5. The plug of claim 1, wherein the plug main body further comprises a circumferential engaging groove located behind the circumferential hook, and wherein a diameter of the circumferential engaging groove is less than a diameter of the plug main body.

6. The plug of claim 1, further comprising a spring, wherein two ends of the spring respectively abut against the piston and the plug rear terminal, wherein the at least two extending portions are substantially three extending portions, and wherein each of the three extending portions has an abutting surface formed at a step at an outermost side of an end of the three extending portions away from the piston main body.

7. The plug of claim 1, further comprising a spring, wherein two ends of the spring respectively abut against the piston and the plug rear terminal, wherein the at least two extending portions are substantially three extending portions, and wherein each of the three extending portions has an abutting surface located at an end of the three extending portions away from the piston main body.

8. The plug of claim 1, further comprising a first rubber ring disposed in a piston groove of the piston head, wherein the first rubber ring contacts an inner surface of the plug main body.

9. The plug of claim 1, further comprising a second rubber ring disposed in an outer accommodating groove of the plug main body, wherein the second rubber ring contacts the plug rear terminal.

10. The plug of claim 9, wherein the outer accommodating groove is recessed from the outer surface of the plug main body.

11. A coupling assembly, comprising:
a plug having a cavity, a front opening and a rear opening respectively located at opposite ends of the cavity, the plug comprising:
a plug main body comprising a circumferential hook protruding from an outer surface of the plug main body, wherein the front opening defines a front end surface of the plug main body;
a plug rear terminal connected to the plug main body, and the rear opening being located at an end of the plug rear terminal away from the plug main body; and
a piston disposed in the cavity, the piston comprising a piston main body, a piston head, and at least two extending portions, wherein the piston main body has a cone surface, the piston head is disposed on the piston main body, and the at least two extending portions are connected to the cone surface of the piston main body, wherein the at least two extending portions extend from the cone surface of the piston main body away from the piston head, and a notch is defined between the at least two extending portions at a side of the piston main body away from the piston head; and
a socket coupled with the plug, the socket comprising:
a socket main body accommodating the plug main body;
a clip ring movably disposed on the socket main body, and a portion of the clip ring being located in the socket main body;
a sleeve disposed in the socket main body, and the plug main body abutting against the sleeve; and
a stem disposed in the socket main body, and the sleeve surrounding the stem, wherein the piston abuts against the stem.

12. The coupling assembly of claim 11, further comprising a label ring disposed on the plug rear terminal, wherein the label ring is located between the plug rear terminal and the plug main body.

13. The coupling assembly of claim 12, wherein the label ring comprises:
a ring main body;
a convex portion protruding outward from the ring main body; and
an inner bump protruding inward from the ring main body,
wherein the convex portion of the label ring defines a maximum diameter of the plug.

14. The coupling assembly of claim 11, wherein the piston head of the plug has a front surface at an end of the piston head away from the piston main body, and the front surface of the piston head extends in parallel with the front end surface of the plug main body.

15. The coupling assembly of claim 11, wherein the plug main body further comprises a circumferential engaging groove located behind the circumferential hook, and wherein a diameter of the circumferential engaging groove is less than a diameter of the plug main body.

16. The coupling assembly of claim 11, wherein the plug further comprises a spring, wherein two ends of the spring respectively abut against the piston and the plug rear terminal, wherein the at least two extending portions are substantially three extending portions, and wherein each of the three extending portions has an abutting surface formed at a step at an outermost side of an end of the three extending portions away from the piston main body.

17. The coupling assembly of claim 11, wherein the plug further comprises a spring, wherein two ends of the spring respectively abut against the piston and the plug rear terminal, wherein the at least two extending portions are substantially three extending portions, and wherein each of the three extending portions has an abutting surface located at an end of the three extending portions away from the piston main body.

18. The coupling assembly of claim 11, further comprising a first rubber ring disposed in a piston groove of the piston head, wherein the first rubber ring contacts an inner surface of the plug main body.

19. The coupling assembly of claim 11, further comprising a second rubber ring disposed in an outer accommodating groove of the plug main body, wherein the second rubber ring contacts the plug rear terminal.

20. The coupling assembly of claim 19, wherein the outer accommodating groove is recessed from the outer surface of the plug main body.
